(19) United States
(12) Patent Application Publication
(10) Pub. No.: US 2018/0156625 A1
(43) Pub. Date: Jun. 7, 2018

(54) AUTOMATED-VEHICLE PICKUP-LOCATION EVALUATION SYSTEM

(71) Applicant: Delphi Technologies, Inc., Troy, MI (US)

(72) Inventors: Nandita Mangal, Palo Alto, CA (US); Michael H. Laur, Mission Viejo, CA (US)

(21) Appl. No.: 15/369,998

(22) Filed: Dec. 6, 2016

(51) Int. Cl. G01C 21/36; G01C 21/34

(52) U.S. Cl. CPC G01C 21/362; G01C 21/3691; G01C 21/3667; G01C 21/3415

(57) ABSTRACT

An automated-vehicle or automated-taxi pickup-location evaluation system includes a communications-network, an object-detector and/or a digitized-map, and a controller. The communications-network is used to send a transportation-request from a client to an automated-taxi, and communicate a preferred-location where the automated-taxi will meet the client. The object-detector is used to detect an object proximate to the preferred-location. The digitized-map is used to determine a route to the preferred-location for the automated-taxi to follow. The controller is in communication with the object-detector and/or the digitized-map, and the communications-network. The controller determines when the object makes the preferred-location unsuitable to pickup the client, and/or that the digitized-map indicates that the preferred-location is unsuitable to use to pickup the client. The controller then determines an alternate-location to pickup the client, and then communicates the alternate-location to one of the client, the automated-taxi, and both the client and the automated-taxi.

### TECHNICAL FIELD OF INVENTION

This disclosure generally relates to an automated-vehicle or automated-taxi pickup-location evaluation system, and more particularly relates to a system that determines when a preferred-location is unsuitable to use to pickup a client, and determines an alternate-location to pickup the client.

### BACKGROUND OF INVENTION

When a client sends a transportation-request for an automated-taxi, a preferred-location for the automated-taxi to meet and pickup the client is typically specified, either by the client or by a dispatcher (human or computerized) of the automated-taxi. However, there are instances or scenarios where the preferred-location is unsuitable, but this unsuitability may be unknown until the moment when the automated-taxi and/or the client arrives at or approaches the preferred-location.

### SUMMARY OF THE INVENTION

In accordance with one embodiment, an automated-taxi pickup-location evaluation system for automated vehicles is provided. The system includes a communications-network, an object-detector, and a controller. The communications-network is used to send a transportation-request from a client to an automated-taxi, and communicate a preferred-location where the automated-taxi will meet the client. The object-detector is used to detect an object proximate to the preferred-location. The controller is in communication with the object-detector and the communications-network. The controller determines when the object makes the preferred-location unsuitable to pickup the client, determines an alternate-location to pickup the client, and communicates the alternate-location to one of the client, the automated-taxi, and both the client and the automated-taxi.

In accordance with another embodiment, an automated-taxi pickup-location evaluation system for automated vehicles is provided. The system includes a communications-network, a digitized-map, and a controller. The communications-network is used to send a transportation-request from a client to an automated-taxi, and communicate a preferred-location where the automated-taxi will meet the client. The digitized-map is used to determine a route to the preferred-location for the automated-taxi to follow. The controller is in communication with the communications-network and the digitized-map. The controller determines that the digitized-map indicates that the preferred-location is unsuitable to pickup the client, determines an alternate-location to pickup the client, and communicates the alternate-location to one of the client, the automated-taxi, and both the client and the automated-taxi.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of an automated-taxi pickup-location evaluation system in accordance with one embodiment;

FIG. 2 is a traffic scenario navigated by the system of FIG. 1 in accordance with one embodiment; and

FIG. 3 is another traffic scenario navigated by the system of FIG. 1 in accordance with one embodiment.

### DETAILED DESCRIPTION

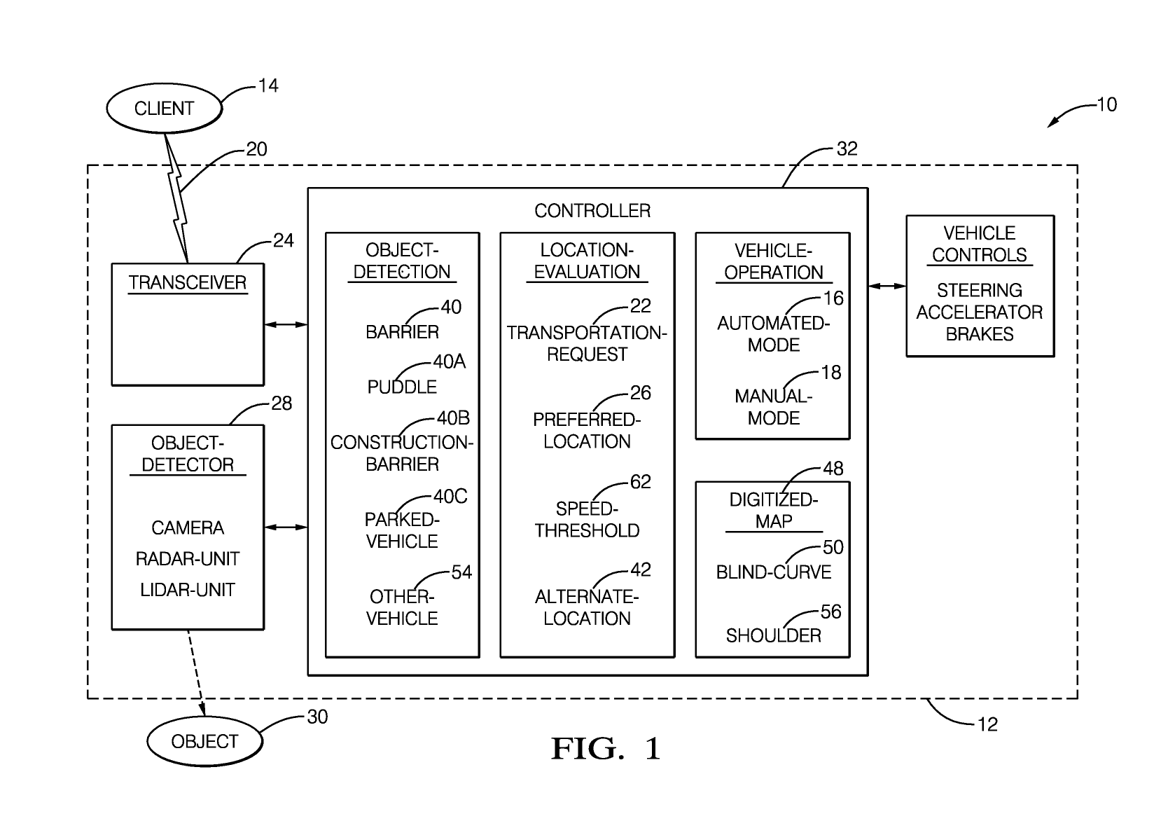

FIG. 1 illustrates a non-limiting example of an automated-taxi pickup-location evaluation system 10, hereafter referred to as the system 10. In general, the system 10 is suitable for use by an automated vehicle such as an automated-taxi 12 to meet, pickup, and transport a client 14. As used herein, the term automated vehicle may apply to instances when the automated-taxi 12 is being operated in an automated-mode 16, i.e. a fully autonomous mode, where there is no human-operator of the automated-taxi 12, or a human-operator (not shown) of the automated-taxi 12 may do little more than designate a destination in order to operate the automated-taxi 12. However, full automation is not a requirement. It is contemplated that the teachings presented herein are useful when the automated-taxi 12 is operated in a manual-mode 18 where the degree or level of automation may be little more than providing an audible or visual assistance to the human-operator to meet, pickup, and transport the client 14. That is, when operating in the manual-mode 18, the human-operator may be generally in control of the steering, accelerator, and brakes of the automated-taxi 12, and the automation aspect merely helps to identify the client 14.

The system 10 includes a communications-network 20 used to send a transportation-request 22 from the client 14 to the automated-taxi 12. While FIG. 1 suggests that there is a direct wireless connection between the client 14 and the automated-taxi 12, this is only to simplify the illustration. It is contemplated that there may be some type of dispatcher (not shown, but various examples of human and computerized dispatchers are known) that controls, configures, and/or routes communications between the client 14 and the automated-taxi 12. The communications-network 20 may use the Internet, a cellular-phone network, a private radio, or any combination thereof. Accordingly, the automated-taxi 12 may be equipped with a transceiver 24 configured to communicate via any one or combination of known communications networks.

The system 10 also uses the communications-network 20 to communicate a preferred-location 26 where the automated-taxi 12 will meet the client 14. The preferred-location 26 may be determined by a variety of methods including, but not limited to, being determined or specified by the client 14, being selected by the client 14 from a provided list, or recommended or specified by the aforementioned dispatcher. That is, the preferred-location 26 maybe communicated from the client 14 to the automated-taxi 12, or maybe communicated to the client 14 by the dispatcher or the automated-taxi 12. By way of further example and not limitation, the preferred-location 26 may be an area specified by the government or proprietor of an establishment, or it may be a dynamically defined area such as along a curb of a section of roadway that is within a predetermined distance (e.g. fifty meters) from an address indicated or provided by the client 14.

In one embodiment, the system 10 includes an object-detector 28 used to detect an object 30 proximate to the preferred-location 26. As used herein, use of the phrase ‘proximate to’ means that the relative-location of the object 30 with respect to the preferred-location 26 is close enough that the object 30 could somehow interfere with, obstruct, or otherwise make unsafe the action of the automated-taxi 12 attempting to approach the preferred-location 26 in order to pickup the client 14. That is, if the object 30 is ‘proximate to’ the preferred-location 26, then the relative-location of the object 30 may not allow the client 14 to safely or conveniently board the automated-taxi 12, or may not allow the automated-taxi 12 to approach and stop at the preferred-location 26 without causing a safety problem for other-vehicles (not shown) or other pedestrians (not shown).

The object-detector 28 may be a camera, a radar-unit, a lidar-unit, ultrasonic-transducer, or any combination thereof. The one or combination of devices/technologies that make up the object-detector 28 may be attached to the automated-taxi 12, or may be located at or near the preferred-location 26 which would likely mean that the object-detector 28 was part of a larger traffic/pedestrian sensing network. That is, it is not a requirement that the object-detector 28 be mounted on or attached to the automated-taxi 12, but rather the object-detector 28 could be located remote from the automated-taxi 12.

The system 10 includes a controller 32 in communication with the object-detector 28 and the communications-network 20. The controller 32 may include a processor (not specifically shown) such as a microprocessor or other control circuitry such as analog and/or digital control circuitry including an application specific integrated circuit (ASIC) for processing data as should be evident to those in the art. The controller 32 may include memory (not specifically shown), including non-volatile memory, such as electrically erasable programmable read-only memory (EEPROM) for storing one or more routines, thresholds, and captured data. The one or more routines may be executed by the processor to perform steps for determining the relative positions of the automated-taxi 12, the client 14, and the preferred-location 26 based on signals received by the controller 32 from the object-detector 28 as described herein.

While the controller 32 is illustrated as being part of the automated-taxi 12, this is only to simplify the explanation and illustration. It is contemplated that the controller 32 could be located remote from the automated-taxi 12, the client 14, and the preferred-location 26. For example, the controller 32 could be located at the dispatcher (not shown) or located ‘in the cloud’. It is also contemplated that some portions of what is shown in FIG. 1 as being part of the automated-taxi 12 could be located remote from the automated-taxi 12, and other portions located in the automated-taxi 12.

The controller 32 may be configured to determine when the presence or behavior of the object 30 makes the preferred-location 26 unsuitable to use to pickup the client 14. That is, as will be explained in more detail below by way of non-limiting examples, the controller 32 may evaluate images provided by the camera and/or target range and range-rate information from the radar-unit or lidar-unit to determine when the object 30 is at or is approaching the preferred-location 26, and determine when the object 30 may interfere with or otherwise make it unsafe for the automated-taxi 12 to approach and/or stop at the preferred-location 26 to pickup the client 14.

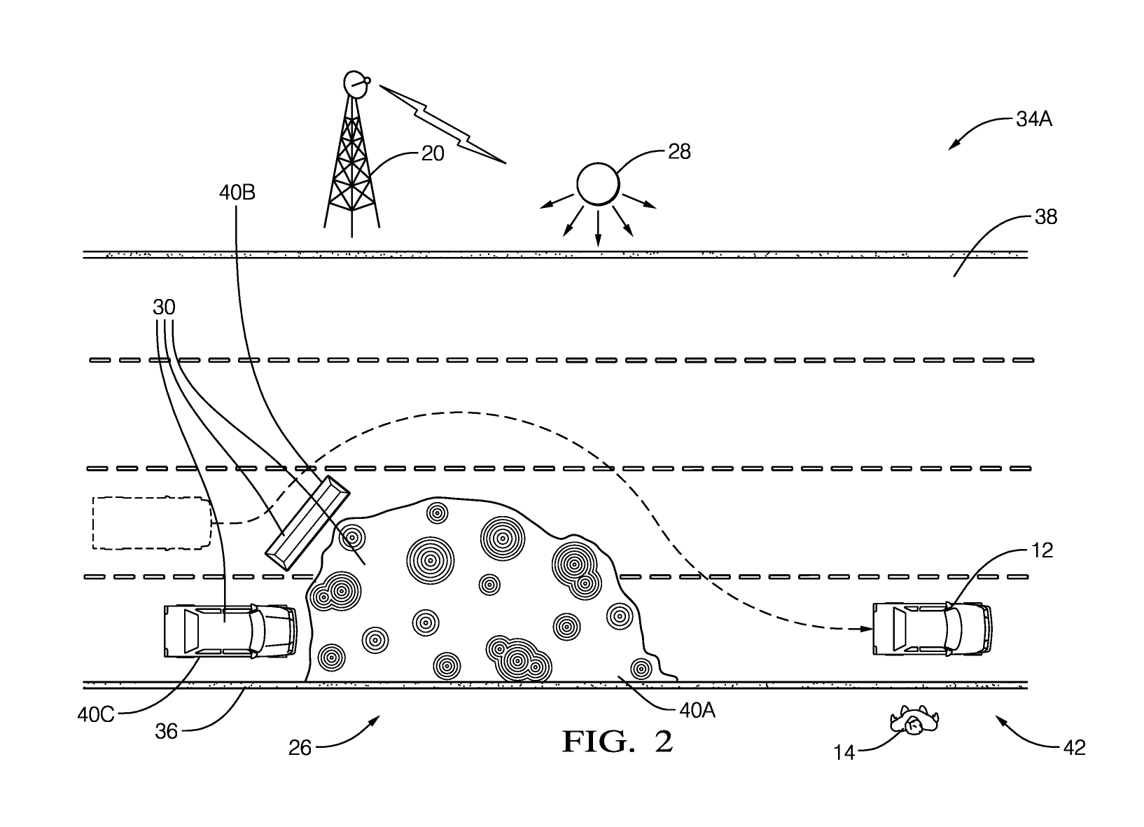

FIG. 2 illustrates a non-limiting example of a traffic-scenario 34A where the preferred-location 26 is adjacent to a curb 36 of a roadway 38, and the object 30 is a barrier 40. The barrier 40 may be, but is not limited to, any one or combination of a puddle 40A, a construction-barrier 40B, and/or a parked-vehicle 40C. The accumulation of water to form the puddle 40A and/or the presence of one or more instances of the parked-vehicle 40C and/or the presence of one or more instances of the construction-barrier 40B (which could be present for reasons other than the presence of the puddle 40A) makes it difficult or impossible for the automated-taxi 12 to approach the preferred-location 26.

Based on information from the object-detector 28, which is shown in FIG. 2 located across the roadway 38 from the preferred-location 26, i.e. not mounted on the automated-taxi 12, the controller 32 may determine that the preferred-location 26 is unsuitable when the barrier 40 prevents the automated-taxi 12 from approaching the preferred-location 26. To ameliorate this situation where the automated-taxi 12 cannot or should not approach or stop at the preferred-location 26, the controller 32 determines an alternate-location 42 to pickup the client 14. While in this instance the distance between the preferred-location 26 and the alternate-location 42 appears to be only a few tens of meters, it is contemplated that situations will arise where longer distances are necessary. For example, if the client 14 is arriving by airplane at an airport, the controller 32 may instruct the client 14 use in-airport travel means (e.g. shuttle train) to take the client 14 to the alternate-location 42 which is at the other end of the airport, possible kilometer away from the preferred-location 26.

In this scenario where the object-detector 28 is remote from the automated-taxi 12, the controller 32 communicates the alternate-location 42 to both the client 14 and the automated-taxi 12. Alternatively, if the object-detector 28 and the controller 32 are mounted on the automated-taxi 12, the controller 32 communicates the alternate-location 42 to the client 14 when the automated-taxi 12 finds that the preferred-location 26 is unsuitable to pickup the client 14. Alternatively, it may be that the client 14 arrives at the preferred-location 26 first, and the client 14 determines that the preferred-location 26 is unsuitable for any of the above reasons, or other reasons. For example, there may be a situation at the preferred-location that may threaten the sense of security of the client 14, so the alternate-location is selected or designated by the client 14.

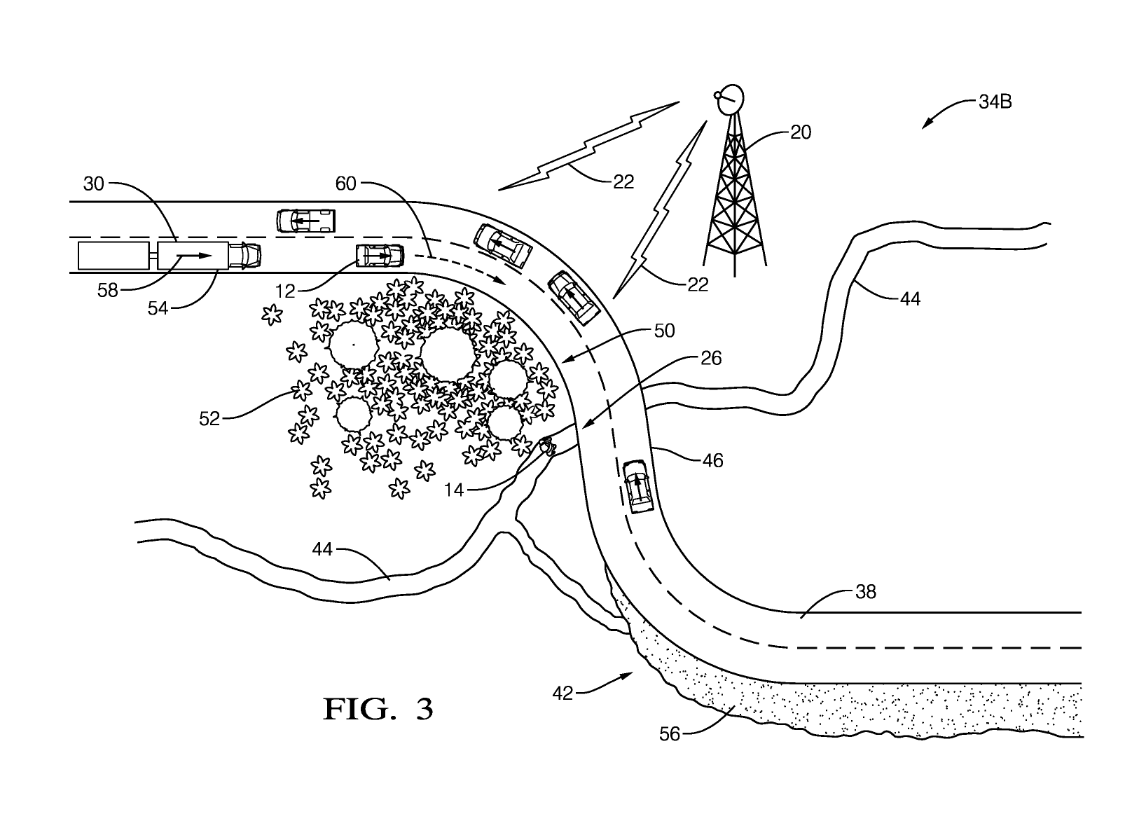

FIG. 3 illustrates a non-limiting example of a traffic-scenario 34B where the client 14 uses the communications-network 20 used to send a transportation-request 22 to an automated-taxi 12, and communicate the preferred-location 26 where the automated-taxi 12 will meet the client 14. In this scenario the client 14 has indicated that the preferred-location 26 is where the client 14 is shown adjacent to (e.g. within a ten meters of) where a hiking-trail 44 crosses a two-lane road 46.

The system 10 may include or have access to a digitized-map 48 that may be used to determine a route 60 to the preferred-location 26 for the automated-taxi 12 to follow. However, the controller 32 may determine that the digitized-map 48 indicates that the preferred-location 26 is unsuitable to pickup the client 14, determine an alternate-location to pickup the client 14, and communicate the alternate-location 42 to (depending on where the controller 32 is located) the client 14, the automated-taxi 12, or both the client 14 and the automated-taxi 12. By way of example and not limitation, the controller 32 may determine that the preferred-location 26 is unsuitable when the digitized-map 48 indicates that the preferred-location 26 is at a blind-curve 50. For example, the shape of the two-lane road 46 and the presence of vegetation 52 or landmass may obstruct a distant-view of the preferred-location 26 so that, for example, an other-vehicle 54 (e.g. a large truck) would not be able to stop in time to prevent a collision if the automated-taxi 12 stopped on the two-lane road 46 at the preferred-location 26.

Alternatively, the digitized-map 48 may indicate the configuration of the roadway 38 such the number of lanes of the roadway and the presence of a shoulder alongside or adjacent to the roadway 38 where the automated-taxi 12 can pull-over and stop without obstructing traffic. That is, the controller 32 determines that the preferred-location 26 is unsuitable when the digitized-map 48 indicates that the preferred-location 26 does not provide a shoulder 56 of the roadway 38. The controller 32 may be further configured to contact the client 14 via the communications-network 20 to instruct the client to follow the hiking-trail 44 to the shoulder 56 thereby designating the shoulder as the alternate-location 42.

By way of another example, the object 30 may be an other-vehicle 54, e.g. a large truck, detected by the object-detector 28 while approaching the preferred-location 26 from behind the automated-taxi 12. If a speed 58 of the other-vehicle 54 is greater than a speed-threshold 62, which may be determined based on the curvature and/or grade (uphill vs. downhill) of the roadway 38 and/or the configuration of the other-vehicle 54 (sports car vs. large truck), where the configuration may be determined using image processing or communicated via a vehicle communications network.

Accordingly, an automated-taxi pickup-location evaluation system (the system 10), a controller 32 for the system 10, and a method of operating the system 10 is provided. The system 10 provides for a means to change the pickup-location for an automated-taxi to meet and pickup a client from a preferred-location 26 to an alternate-location when the system 10 or the client 14 determines that the preferred-location 26 is not suitable for a variety of reasons.

While this invention has been described in terms of the preferred embodiments thereof, it is not intended to be so limited, but rather only to the extent set forth in the claims that follow.

We claim:

1. An automated-taxi pickup-location evaluation system for automated vehicles, said system comprising:
a communications-network used to send a transportation-request from a client to an automated-taxi, and communicate a preferred-location where the automated-taxi will meet the client;
an object-detector used to detect an object proximate to the preferred-location; and
a controller in communication with the object-detector and the communications-network, wherein the controller determines when the object makes the preferred-location unsuitable to pickup the client, determines an alternate-location to pickup the client, and communicates the alternate-location to one of the client, the automated-taxi, and both the client and the automated-taxi.

2. The system in accordance with claim 1, wherein the object is a barrier, and the controller determines that the preferred-location is unsuitable when the barrier prevents the automated-taxi from approaching the preferred-location.

3. The system in accordance with claim 2, wherein the barrier is one of a puddle, a construction-barrier, and a parked-vehicle.

4. The system in accordance with claim 1, wherein the object is an other-vehicle approaching the preferred-location, and the controller determines that the preferred-location is unsuitable when a speed of the other-vehicle is greater than a speed-threshold.

5. The system in accordance with claim 1, wherein the system includes a digitized-map, and the controller determines that the preferred-location is unsuitable when the digitized-map indicates that the preferred-location is at a blind-curve.

6. An automated-taxi pickup-location system for automated vehicles, said system comprising:
a communications-network used to send a transportation-request from a client to an automated-taxi, and communicate a preferred-location where the automated-taxi will meet the client;
a digitized-map used to determine a route to the preferred-location for the automated-taxi to follow;
a controller in communication with the communications-network and the digitized-map, wherein the controller determines that the digitized-map indicates that the preferred-location is unsuitable to pickup the client, determines an alternate-location to pickup the client, and communicates the alternate-location to one of the client, the automated-taxi, and both the client and the automated-taxi.

7. The system in accordance with claim 6, wherein the controller determines that the preferred-location is unsuitable when the digitized-map indicates that the preferred-location is at a blind-curve.

8. The system in accordance with claim 6, wherein the controller determines that the preferred-location is unsuitable when the digitized-map indicates that the preferred-location does not provide a shoulder.
